(19) United States
(12) Patent Application Publication
(10) Pub. No.: US 2024/0145125 A1
(43) Pub. Date: May 2, 2024

(54) WATER-STOP STRUCTURE OF WIRE BUNDLE AND MANUFACTURING METHOD THEREOF

(71) Applicant: Yazaki Corporation, Tokyo (JP)

(72) Inventors: Eiichi TOHYAMA, Shizuoka (JP); Michitake MASUDA, Shizuoka (JP); Hideyuki WADA, Shizuoka (JP)

(73) Assignee: Yazaki Corporation, Tokyo (JP)

(21) Appl. No.: 18/490,185

(22) Filed: Oct. 19, 2023

(30) Foreign Application Priority Data
Oct. 31, 2022 (JP) 2022-174218

(51) Int. Cl. H01B 7/285; H01B 17/58

(52) U.S. Cl. CPC H01B 7/285; H01B 17/58

(57) ABSTRACT

A water-stop structure of a wire bundle includes a plurality of wires, a thermoplastic resin sheet being provided to be wound around the plurality of wires, and a heat shrinkable tube with which the thermoplastic resin sheet is covered. A gap between the plurality of wires is filled with the thermoplastic resin sheet being heated and softened.

### CROSS-REFERENCE TO RELATED APPLICATIONS

The present application is based on, and claims priority from the prior Japanese Patent Application No. 2022-174218, filed on Oct. 31, 2022, the entire contents of which are incorporated herein by reference.

### TECHNICAL FIELD

The present disclosure relates to a water-stop structure of a wire bundle and a manufacturing method thereof.

### BACKGROUND

In the related art, when a wire bundle (wire harness) passes through a through hole that is formed in advance in a plate material, a grommet to be attached to a peripheral edge portion of the through hole is provided to protect the wire bundle from the peripheral edge portion of the through hole. In some cases, the wire bundle is subjected to water-stop treatment in order to prevent entry of water from one end side (an engine room side) to the other end side (inside of a vehicle cabin) of the through hole through a gap between wires of the wire bundle. In JP 2017-10649 A, water-stop is performed by a method of inserting a wire bundle into a through hole of a grommet and filling a gap between wires with a water-stop agent such as silicone.

### SUMMARY

However, when each of wires in a wire bundle is thick, a gap between the wires is increased, and a water-stop agent such as silicone may not adequately penetrate into this large gap. As a result, the gap between the wires cannot adequately be filled with the water-stop agent.

The present disclosure has been made in view of this problem in the related art. Further, an object of the present disclosure is to provide a water-stop structure of a wire bundle and a manufacturing method thereof that can adequately fill a gap between a plurality of wires even when each of the wires in the wire bundle is thick.

A water-stop structure of a wire bundle according to an embodiment includes a plurality of wires, a thermoplastic resin sheet being provided to be wound around the plurality of wires, and a heat shrinkable tube with which the thermoplastic resin sheet is covered. A gap between the plurality of wires is filled with the thermoplastic resin sheet being heated and softened.

A manufacturing method of a water-stop structure of a wire bundle according to an embodiment includes winding a thermoplastic resin sheet around a plurality of wires, covering the thermoplastic resin sheet with a heat shrinkable tube, and heating the heat shrinkable tube to soften the thermoplastic resin sheet and filling a gap between the plurality of wires with the thermoplastic resin sheet being softened.

According to the configuration described above, it is possible to provide a water-stop structure of a wire bundle and a manufacturing method thereof that can adequately fill a gap between a plurality of wires even when each of the wires in the wire bundle is thick.

### BRIEF DESCRIPTION OF THE DRAWINGS

FIG. 1 is a perspective view schematically illustrating an example of a water-stop structure of a wire bundle according to an embodiment.

FIG. 2 is a plan view schematically illustrating an example of the water-stop structure of the wire bundle according to the embodiment.

FIG. 3 is a cross-sectional view taken along the line A-A in FIG. 2.

FIG. 4 is an explanatory view illustrating an example of a step in a manufacturing method of a water-stop structure of a wire bundle.

FIG. 5 is an explanatory view illustrating an example of a step in the manufacturing method of a water-stop structure of a wire bundle.

FIG. 6 is an explanatory view illustrating an example of a step in the manufacturing method of a water-stop structure of a wire bundle.

### DETAILED DESCRIPTION

Various embodiments will be described hereinafter with reference to the accompanying drawings.

With reference to the drawings, a water-stop structure of a wire bundle and a manufacturing method thereof according to the present embodiment is described below in detail. Note that dimensional ratios in the drawings are exaggerated for convenience of description, and may be different from actual ratios.

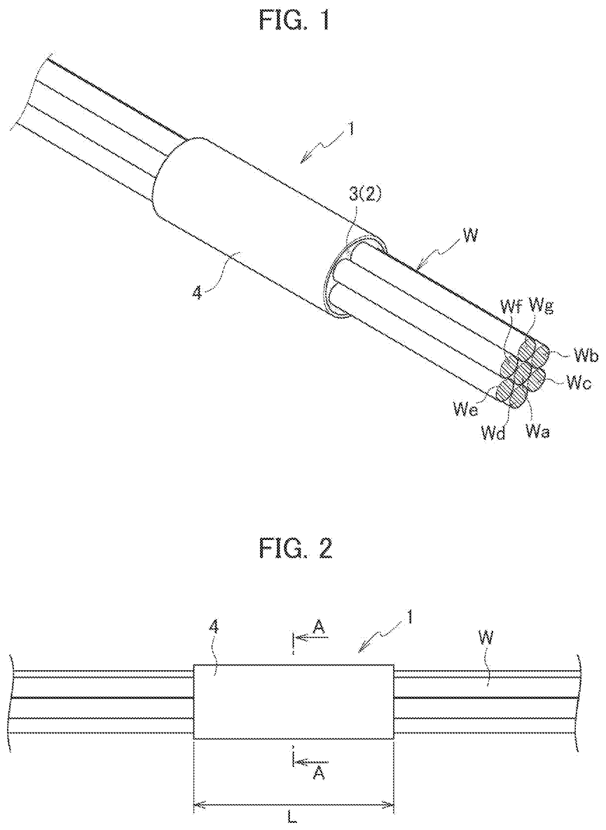

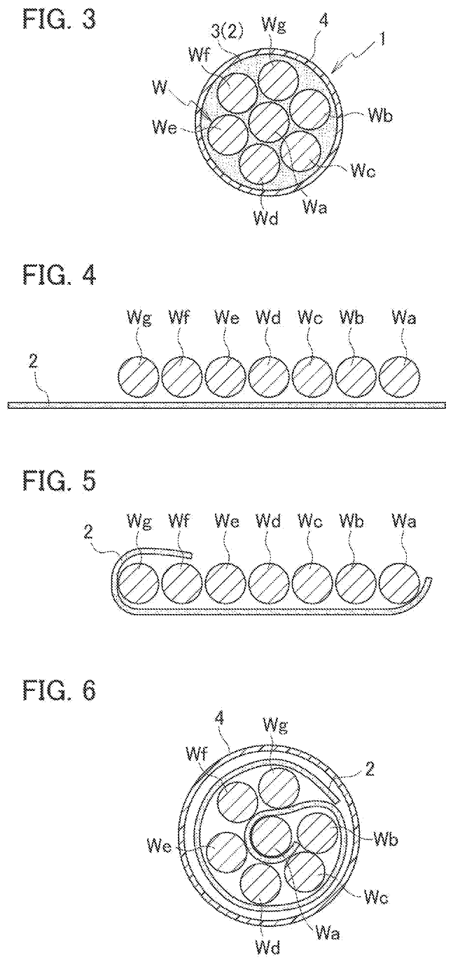

FIG. 1 is a perspective view illustrating a water-stop structure of a wire bundle W according to the present embodiment, FIG. 2 is a plan view illustrating the water-stop structure 1 of the wire bundle W according to the present embodiment, and FIG. 3 is a cross-sectional view taken along the line A-A in FIG. 2.

The water-stop structure 1 according to the present embodiment includes the wire bundle W, which is also referred to as a wire harness, a thermoplastic resin layer 3, and a heat shrinkable tube 4.

The wire bundle W is obtained by collecting a plurality of (seven in the illustrated example) thick wires Wa, Wb, Wc, Wd, We, Wf, and Wg in a bundle (a bundle of heavy wires), and those wires Wa to Wg extend in parallel to one another. In the present embodiment, the wire Wa being one of the plurality of wires Wa to Wg is arranged in the center portion of the wire bundle W. However, the present embodiment is not limited thereto, and two or more wires of the plurality of wires Wa to Wg may be arranged in the center portion of the wire bundle W. Note that the terms “thick wire” and “heavy wire” in this specification refer to a wire having a diameter of 5 mm or larger, for example.

The thermoplastic resin layer 3 is formed of a thermoplastic resin sheet 2 such as a butyl sheet and a hot-melt sheet (thermoplastic polymer sheet), and the thermoplastic resin sheet 2 is provided to be wound around the plurality of wires Wa to Wg. Further, the thermoplastic resin sheet 2 is provided to be wound around the plurality of wires Wa to Wg while contacting all the plurality of wires Wa to Wg. Although details thereof are described later, when the heat shrinkable tube 4 is heated, the thermoplastic resin sheet 2 is softened, and a gap between the plurality of wires Wa to Wg is filled with the thermoplastic resin sheet 2 being softened. After that, the thermoplastic resin layer 3 is formed by cooling and solidifying the thermoplastic resin sheet 2 being softened.

The plurality of wires Wa to Wg constituting the wire bundle W and the thermoplastic resin layer 3 (the thermoplastic resin sheet 2) are covered with the heat shrinkable tube 4. A length L of the heat shrinkable tube 4 (see FIG. 2) is approximately 50 mm, for example. The heat shrinkable tube 4 is formed of a synthetic resin material such as a polyolefin-based resin. Further, the heat shrinkable tube 4 may have a double-layer structure obtained by providing an adhesive layer in an inner layer, or may be a single-layer structure without providing an adhesive layer in an inner layer. For example, the adhesive layer (adhesive) that is provided in the inner layer of the heat shrinkable tube 4 is formed of a hot-melt adhesive that contains a thermoplastic polymer as a component and has a melting point near 90 degrees Celsius.

A manufacturing method of the water-stop structure 1 of the wire bundle W according to the present embodiment is described below.

Each of FIG. 4 to FIG. 6 is an explanatory view illustrating a step in the water-stop structure 1 of the wire bundle W according to the present embodiment.

First, the thermoplastic resin sheet 2 is arranged while contacting all the plurality of wires Wa to Wg of the wire bundle W (see FIG. 4).

Subsequently, the thermoplastic resin sheet 2 on which the plurality of wires Wa to Wg are arranged side by side is rolled up into a cylindrical shape (see FIG. 5). In other words, the thermoplastic resin sheet 2 are wound around the plurality of wires Wa to Wg in a spiral manner as viewed in the longitudinal direction of the wire bundle W, while contacting all the plurality of wires Wa to Wg.

Subsequently, the thermoplastic resin sheet 2 that is rolled up into a cylindrical shape is covered with the heat shrinkable tube 4 and arranged (see FIG. 6).

Then, the heat shrinkable tube 4 is heated to soften the thermoplastic resin sheet 2, and the gap between the plurality of wires Wa to Wg is filled with the thermoplastic resin sheet 2 being softened. After the heat shrinkable tube 4 is heated, the heat shrinkable tube 4 is cooled (including natural cooling). In this manner, the thermoplastic resin layer 3 is formed by cooling and solidifying the thermoplastic resin sheet 2 that fills the gap between the plurality of wires Wa to Wg (see FIG. 3).

The heat shrinkable tube 4 may have a double-layer structure obtained by providing an adhesive layer in an inner layer, or may be a single-layer structure without providing an adhesive layer in an inner layer.

Due to the shrinkage power of the heat shrinkable tube 4 and the phenomenon in which the thermoplastic resin sheet 2 is softened through heating, the thermoplastic resin sheet 2 being softened penetrates adequately into the gap between the plurality of wires Wa to Wg.

After shrinkage of the heat shrinkable tube 4, the cross-sectional shape of the portion of the wire bundle W that is covered with the heat shrinkable tube 4 is a circular shape. Thus, a grommet (omitted in illustration) can be arranged on the heat shrinkable tube 4, and water-stop treatment for the wire bundle W is completed.

The thermoplastic resin sheet 2 is arranged on the wire bundle W, and the heat shrinkable tube 4 is subjected to heat shrinkage treatment through the thermoplastic resin sheet 2. With this, the gap between the plurality of wires Wa to Wg is sealed with the thermoplastic resin sheet 2. Thus, even when the plurality of wires Wa to Wg are thick wires, the wire bundle W on which the heat shrinkable tube 4 is mounted can collectively be inserted into a grommet.

Next, effects of the water-stop structure 1 of the wire bundle W are described.

As described above, the water-stop structure 1 of the wire bundle W according to an aspect of the present embodiment includes the plurality of wires Wa to Wg, the thermoplastic resin sheet 2 being provided to be wound around the plurality of wires Wa to Wg, and the heat shrinkable tube 4 with which the thermoplastic resin sheet 2 is covered. The gap between the plurality of wires Wa to Wg is filled with the thermoplastic resin sheet 2 being heated and softened.

When the heat shrinkable tube 4 on the thermoplastic resin sheet 2 arranged around the wire bundle W is shrunken, the wire bundle W and the thermoplastic resin sheet 2 are brought into close contact with each other by heat applied at the time of shrinkage and the shrinkage power of the heat shrinkable tube 4, and the gap between the plurality of wires Wa to Wg is filled. Then, the thermoplastic resin layer 3 is formed by cooling and solidifying the thermoplastic resin sheet 2 that fills the gap between the plurality of wires Wa to Wg. Further, the smooth and circular cross-sectional shape is formed due to shrinkage of the heat shrinkable tube 4, and hence the water-stop performance of the water-stop structure 1 can be secured by arranging a grommet directly on the heat shrinkable tube 4.

When the thermoplastic resin sheet 2 is softened through heat applied at the time of shrinkage of the heat shrinkable tube 4, fluidity of the thermoplastic resin sheet 2 can be secured. Thus, filling (permeation) of the gap between the plurality of wires Wa to Wg with the thermoplastic resin sheet 2 can be achieved by utilizing a pressure (shrinkage power) acting toward the center at the time of shrinkage of the heat shrinkable tube 4.

After shrinkage of the heat shrinkable tube 4, the cross-sectional shape of the portion of the wire bundle W that is covered with the heat shrinkable tube 4 is a circular shape. Thus, a grommet can be arranged on the heat shrinkable tube 4, and water-stop treatment for the wire bundle W is completed.

The thermoplastic resin sheet 2 is arranged on the wire bundle W, and the heat shrinkable tube 4 is subjected to heat shrinkage treatment through the thermoplastic resin sheet 2. With this, the gap between the plurality of wires Wa to Wg is sealed with the thermoplastic resin sheet 2. Thus, even when the plurality of wires Wa to Wg are thick wires, the wire bundle W on which the heat shrinkable tube 4 is mounted can collectively be inserted into a grommet.

With this, the need for work to fill a gap between wires with a water-stop agent, which is required in the related art, is not required, and labor and efforts required for manual work are reduced. Thus, entry of water between the plurality of wires Wa to Wg can securely be prevented, quality can be improved, and labor saving and cost reduction can be achieved.

In the water-stop structure 1 of the wire bundle W according to an aspect of the present embodiment, the thermoplastic resin sheet 2 may be wound around the plurality of wires Wa to Wg while contacting all the plurality of wires Wa to Wg.

As described above, the thermoplastic resin sheet 2 is arranged to be wound around the plurality of wires Wa to Wg. With this, even when those wires Wa to Wg are heavy wires, the gap therebetween can efficiently be filled.

The manufacturing method of the water-stop structure 1 of the wire bundle W according to an aspect of the present embodiment includes winding the thermoplastic resin sheet 2 around the plurality of wires Wa to Wg and covering the thermoplastic resin sheet 2 with the heat shrinkable tube 4. Further, the manufacturing method of the water-stop structure 1 of the wire bundle W includes heating the heat shrinkable tube 4 to soften the thermoplastic resin sheet 2 and filling the gap between the plurality of wires Wa to Wg with the thermoplastic resin sheet 2 being softened.

When the heat shrinkable tube 4 on the thermoplastic resin sheet 2 arranged around the wire bundle W is shrunken, the wire bundle W and the thermoplastic resin sheet 2 are brought into close contact with each other by heat applied at the time of shrinkage and the shrinkage power of the heat shrinkable tube 4, and the gap between the plurality of wires Wa to Wg is filled. Then, the thermoplastic resin layer 3 is formed by cooling and solidifying the thermoplastic resin sheet 2 that fills the gap between the plurality of wires Wa to Wg. Further, the smooth and circular cross-sectional shape is formed due to shrinkage of the heat shrinkable tube 4, and hence the water-stop performance of the water-stop structure 1 can be secured by arranging a grommet (omitted in illustration) directly on the heat shrinkable tube 4.

When the thermoplastic resin sheet 2 is softened through heat applied at the time of shrinkage of the heat shrinkable tube 4, fluidity of the thermoplastic resin sheet 2 can be secured. Thus, filling (permeation) of the gap between the plurality of wires Wa to Wg with the thermoplastic resin sheet 2 can be achieved by utilizing a pressure (shrinkage power) acting toward the center at the time of shrinkage of the heat shrinkable tube 4.

After shrinkage of the heat shrinkable tube 4, the cross-sectional shape of the portion of the wire bundle W that is covered with the heat shrinkable tube 4 is a circular shape. Thus, a grommet can be arranged on the heat shrinkable tube 4, and water-stop treatment for the wire bundle W is completed.

The thermoplastic resin sheet 2 is arranged on the wire bundle W, and the heat shrinkable tube 4 is subjected to heat shrinkage treatment through the thermoplastic resin sheet 2. With this, the gap between the plurality of wires Wa to Wg is sealed with the thermoplastic resin sheet 2. Thus, even when the plurality of wires Wa to Wg are thick wires, the wire bundle W on which the heat shrinkable tube 4 is mounted can collectively be inserted into a grommet.

In the manufacturing method of the water-stop structure 1 of the wire bundle W according to an aspect of the present embodiment, the thermoplastic resin sheet 2 may be wound around the plurality of wires Wa to Wg while contacting all the plurality of wires Wa to Wg.

As described above, the thermoplastic resin sheet 2 is arranged to be wound around the plurality of wires Wa to Wg. With this, even when those wires Wa to Wg are heavy wires, the gap therebetween can efficiently be filled.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A water-stop structure of a wire bundle, comprising:
a plurality of wires;
a thermoplastic resin sheet being provided to be wound around the plurality of wires; and
a heat shrinkable tube with which the thermoplastic resin sheet is covered, wherein
a gap between the plurality of wires is filled with the thermoplastic resin sheet being heated and softened.

2. The water-stop structure of a wire bundle according to claim 1, wherein
the thermoplastic resin sheet is provided to be wound around the plurality of wires while contacting all the plurality of wires.

3. A manufacturing method of a water-stop structure of a wire bundle, comprising:
winding a thermoplastic resin sheet around a plurality of wires;
covering the thermoplastic resin sheet with a heat shrinkable tube; and
heating the heat shrinkable tube to soften the thermoplastic resin sheet and filling a gap between the plurality of wires with the thermoplastic resin sheet being softened.

4. The manufacturing method of a water-stop structure of a wire bundle according to claim 3, wherein
the thermoplastic resin sheet is wound around the plurality of wires while contacting all the plurality of wires.
